(19) United States
(12) Patent Application Publication
(10) Pub. No.: US 2010/0112518 A1
(43) Pub. Date: May 6, 2010

(54) Conditioning Agent and Method for Binding Hardenable Mixtures to Moulded Bodies Made of Filled High-Temperature Resistant Plastics

(76) Inventors: Jurgen Engelbrecht, Hamburg (DE); Gunther Groger, Elmshorn (DE); Karl-Joachim Gorlich, Furth (DE)

Correspondence Address: LICATA & TYRRELL P.C., 66 E. MAIN STREET, MARLTON, NJ, 08053, US

(21) Appl. No.: 12/531,098

(22) PCT Filed: Mar. 17, 2008
(86) PCT No.: PCT/EP08/02112

§ 371 Date: Sep. 14, 2009

(30) Foreign Application Priority Data
Mar. 16, 2007 (DE) 10 2007 013 285.0

(51) Int. Cl. A61C 13/003; B05D 3/10; B32B 9/04; B32B 27/00; B32B 17/06; B32B 7/12; B32B 19/00; B32B 27/38; A61C 5/08; A61C 13/00

(52) U.S. Cl. 433/167; 427/302; 428/704; 428/473.5; 428/426; 428/702; 428/688; 428/447; 428/413; 428/343; 433/222.1; 433/215

(57) ABSTRACT

The invention describes a conditioning medium, the use thereof in mediating in the adhesion of a hardenable mixture to a shaped article, and a method of pretreating the surfaces of shaped articles made of filler-containing high-temperature-resistant plastics for the purpose of better adhesion of hardenable mixtures to those shaped articles, and also the method products resulting therefrom, especially conditioned shaped articles.

The invention describes a conditioning medium, the use thereof in mediating in the adhesion of a hardenable mixture to a shaped article, and a method of pretreating the surfaces of shaped articles of filler-containing high-temperature-resistant plastics for the purpose of better adhesion of hardenable mixtures to those shaped articles, and also the method products resulting therefrom, especially conditioned shaped articles.

### PRIOR ART

Shaped parts of high-temperature-resistant polymers can generally be regarded as being largely chemically inert. Also, it is generally not possible or hardly possible for them to be partially dissolved by solvents such as, for example, acetone, ethanol, ethyl acetate etc.

It is often necessary for further material to be joined onto a shaped article of high-temperature-resistant plastics. However, this is not straightforward, especially when the connection is to be made not just on a visual level but is also to be mechanically loadable.

As high-temperature-resistant plastics there may be mentioned, for example, high-temperature thermoplastics, which may be either amorphous or crystalline, such as, for example, polyarylates, polyarylene sulfides, polysulfones, liquid crystal polymer, especially liquid crystal polyesters, polyimides, polyamidimides, polyaryl ether ketones and polyether ether ketones or polyoxymethylene.

Polymerisable conditioning media based on methacrylate for pretreating the surfaces of partially dissolvable, non-high-temperature-resistant shaped articles made of polyacrylate, polymethacrylate and polycarbonate plastics, for the purpose of connection to polymerisable methacrylate material, are known.

EP 0 142 172 A2 describes a photo-polymerisable material based on methacrylate, which is suitable as an adhesive or bonding agent for connecting parts made of acrylate plastics to one another or to as yet unhardened methacrylate material. In addition to an initiator for the photo-polymerisation, it comprises acrylic acid or methacrylic acid as polar organic compound, cross-linking dimethacrylates, and methacrylates or methylene chloride as diluent or solvent. It is used especially in the dental sector in the manufacture of dentures made of methacrylate material, in order to repair damaged dentures or to connect false teeth made of acrylate plastic to the methacrylate material forming the denture plate.

In DE 40 00 171 A1 there is claimed a photo-polymerising adhesive which, in addition to methyl methacrylate, a methyl methacrylate polymer and a photoinitiator, comprises a polyfunctional acrylate or methacrylate, preferably a tri- or tetra-acrylate and/or -methacrylate, in an amount of from 1 to 20 percent by weight. That adhesive is suitable for connecting shaped articles of acrylate plastic to other shaped plastic articles, in which case at least one of the shaped plastic articles involved must be sufficiently permeable to the radiation used for curing.

In EP 0 452 540 B1 there is mentioned an adhesive for connecting shaped parts of polycarbonate plastics to one another. This adhesive comprises a peroxide/amine system as catalyst for the cold polymerisation and consists of two components which have to be mixed with one another before use. In addition to the peroxide/amine system, an alkyl methacrylate, 2,2-bis[4-(methacryloyloxyalkoxy)phenyl]propane, the dimethacrylate of an alkanediol and/or trimethacrylate of an alkanetriol and a polymethyl methacrylate are also contained therein.

An orthodontic bracket made of filler-containing methacrylate plastic is known from EP 0 476 789 A1. On the surface to be fixed to a natural tooth with the aid of a light-hardening adhesive, it bears a thin layer of methacrylate plastic partly soluble or swellable in the adhesive. The thin methacrylate plastic layer is obtained by applying and polymerising a mixture of A) 30-70 percent by weight of a monofunctional methacrylate, 30-70 percent by weight of a methacrylate homo- or co-polymer and 0.01-1 percent by weight of a polymerisation catalyst or B) 5-24 percent by weight of a polyfunctional methacrylate, 0-24 percent by weight of a monofunctional methacrylate, 50-90 percent by weight of a silicon dioxide filler and 0.01-1 percent by weight of a polymerisation catalyst.

In EP 0 591 716 B1 there is a described a polymerisable conditioning medium based on methacrylate and a method of pretreating the surface of shaped articles made of polyacrylate, polymethacrylate and polycarbonate plastics before the application of polymerisable methacrylate material and use of the conditioning medium. The conditioning medium or adhesive contains 50-75 percent by weight alkyl methacrylate or a mixture of alkyl methacrylate and butanediol dimethacrylate having at least 50 percent by weight alkyl methacrylate, 15-40 percent by weight diurethane dimethacrylate, 1-15 percent by weight polymethyl methacrylate, 0-5 percent by weight trimethacrylate, tetramethacrylate or a mixture thereof, 0.01-1 percent by weight monocyclic terpene hydrocarbon and 0.1 percent by weight polymerisation catalyst. The alkyl methacrylate is methyl methacrylate and/or ethyl methacrylate, the trimethacrylate is trimethylol propane trimethacrylate and the monocyclic terpene hydrocarbon is terpinolene. The method for pretreating the surface of shaped articles made of polyacrylate, polymethacrylate and polycarbonate plastics consists of applying a thin layer of the adhesive or conditioning medium.

All the mentioned publications describe a conditioning medium or adhesive for pretreating the surfaces of shaped articles made of non-high-temperature-resistant, generally partially dissolvable polyacrylate, polymethacrylate and polycarbonate plastics for the purpose of connection to polymerisable acrylate and/or methacrylate material.

### Problem of the Invention

The problem of the present invention was to make available a conditioning medium for mediating in the adhesion of a hardenable mixture to a shaped article of high-temperature-resistant plastics, the corresponding provision of the conditioning medium in the form of a kit, a method of pretreating the surfaces of shaped articles made of filler-containing high-temperature-resistant plastics for the purpose of better adhesion of hardenable mixtures to those shaped articles, and also the method products resulting therefrom, especially conditioned shaped articles.

### DETAILED DESCRIPTION OF THE INVENTION

In accordance with the invention it was possible to solve the problem at least for those non-partially-dissolvable, high-temperature-resistant plastics to which fillers have been added.

Such filler-containing plastics are described, for example, in WO 2006/108647.

Accordingly, it was possible to solve the set problem by means of a:

conditioning medium for mediating in the adhesion of a hardenable mixture to a shaped article comprising a high-temperature-resistant plastic and a filler, the conditioning medium comprising the following components:
a) an adhesive agent which can adhere to the filler of the shaped article and to at least one component of the hardenable mixture,
b) optionally, one or more catalysts for mediating in the adhesion of the hardenable mixture to the filler of the shaped article and/or for the hardening of the hardenable mixture,
c) a higher-boiling solvent having a dipole character,
d) optionally, a low-boiling solvent,
e) optionally, additives such as stabilisers, inhibitors, antioxidants and/or mono- and/or poly-functional (meth)acrylates.

In applications in the medical sector or dental sector, in order to minimise irritation of living tissue from filler particles protruding from the plastic matrix, it is advantageous to cover the high-temperature-resistant filler-containing thermoplastics with hardenable mixtures. Covering of the shaped articles with a hardenable mixture is frequently necessary on aesthetic grounds. It is moreover possible, by that means, to obtain tailor-made adaptation of the geometry of mass-produced shaped articles to the particular requirements of the individual patients. In the dental sector, these shaped articles can be, for example, dentures, parts of dentures, crowns, bridges, inlays, onlays etc. Combination with coverings that remain soft is also advantageous in this context.

In order to cause the hardenable mixtures to adhere well to the shaped articles and to obtain especially good results with the conditioning media according to the invention, the shaped articles can be pretreated preferably by mechanical methods such as, for example, grinding, sand-blasting, milling or similar methods.

In accordance with the invention, the conditioning medium is made available preferably together with the shaped article in the form of a kit, in which case, optionally, the hardenable mixture is additionally made available. Accordingly, the present invention relates also to a kit comprising

(i) a shaped article comprising a high-temperature-resistant plastic and a filler,

(ii) a conditioning medium comprising an adhesive agent and a higher-boiling solvent having a dipole character, and,

(iii) optionally, a hardenable mixture.

As suitable filler-containing high-temperature-resistant plastics there come into consideration polyarylates, polyarylene sulfides, polysulfones, liquid crystal polymer, polyimides, polyetherimides, polyamidimides, polyaryl ether ketones or copolymerisation products of at least two of the afore-mentioned polymers or a blend of at least two of the afore-mentioned polymers. Having regard to applications in the medical sector, special preference is given in this context to polyaryl ether ketones (PAEK) such as, for example, polyether ketone (PEK), polyether ether ketone (PEEK), polyether ketone ketone (PEKK), polyether ether ketone ketone (PEEKK) or polyether ketone ether ketone ketone (PEKEKK) as published in WO 2006/108647 A1.

In the present Application, the terms “high-temperature-resistant plastic”, “high-temperature-resistant polymer”, “high-temperature thermoplastics” and “high-temperature-resistant thermoplastics” are to be understood as being synonyms. The term “high-temperature-resistant” means that the plastics are resistant, that is to say they do not change shape, up to a temperature of at least 200° C., preferably up to a temperature of at least 250° C. This possible pronounced heating of the mass for shaping brings about an improvement in the mechanical properties and also a reduction in intrinsic stresses and shrinkage and also distortion and consequently results in better dimensional stability and dimensional accuracy with improved mechanical properties of the shaped part. Above all, the mechanical properties are stabilised in all directions so that isotropic characteristics are brought about in the shaped part, which has the same mechanical properties in all directions. This is important especially for use in the dental sector, where very high torsional loads can occur in the shaped dental parts as a result of chewing and the intrinsic mobility of the teeth.

The fillers used according to the invention can be of an inorganic or organic type such as mineral flours or polymer powders. Preference is given, however, to those fillers which are of an inorganic type, for example those mineral flours, when they are chemically activatable and linkable. As examples in this context there may be mentioned: microfine glass fibres, glass spheres, glass flours, silicic acids, quartz flour, mica, corundum, kaolin, talc, inorganic pigments, apatites etc.

The afore-mentioned fillers can be included in amounts of 1-90 percent by weight, preferably 5-80 percent by weight, especially 20-60 percent by weight, more especially 25-40 percent by weight, in each case based on the shaped article. They can, in their turn, be surface-treated, for example with functional silanes such as, for example, vinyl silanes, methacryl silanes, epoxy silanes, amino silanes, hydroxy silanes etc., phosphoric acid esters, phosphonic acid esters, carboxylic acid esters and/or mixtures thereof.

The hardenable mixtures to be applied to the shaped articles can be of various types. They can be polymerising mixtures, for example, based on monomers having vinyl, epoxide, isocyanate or other groups.

Preference is given to polymerising mixtures based on (meth)acrylates; special preference is given to those that are customary in dental restoration mixtures.

The conditioning medium according to the invention includes an adhesive agent which can bond to the fillers of the high-temperature-resistant plastic and/or to components of the hardenable mixture. As adhesive agent there may be present functional silanes, that is to say silanes having functional groups such as, for example, vinyl silanes, (meth)acryl silanes, epoxy silanes, amino silanes, hydroxy silanes etc. and/or mixtures thereof. Furthermore, functional phosphoric acid esters, phosphonic acid esters and/or carboxylic acid esters and/or mixtures thereof may be present. The adhesive agent may be present in the conditioning medium in an amount of 0.1-100 percent by weight, preferably 0.1-80 percent by weight, more preferably 1-50 percent by weight, even more preferably 1-25 percent by weight, in each case based on the conditioning medium.

Optionally, the conditioning agent may comprise one or more catalysts for bonding of the hardenable mixture to the filler of the high-temperature-resistant plastic and/or for the hardening of the hardenable mixture. Depending on the chemical nature of the hardenable mixture, the conditioning medium may include various catalysts or also be present as a single- or multi-component system. Multi-component systems are mixed together shortly before use.

Conditioning media may include, for example, catalysts for cold, hot and/or photo-polymerisation. For example, these can be, for a hardenable mixture based on methacrylates and cold polymerisation, peroxide/amine systems such as, for example, dibenzoyl peroxide/N,N-dimethyl-p-toluidine and, in the case of photo-polymerisation, ketone/amine systems such as, for example, camphorquinone/amine, acylphosphine oxide such as, for example, diphenyl(2,4,6-trimethylbenzoyl)phosphine oxide and a propanone derivative and/or mixtures thereof. The amount of catalyst is preferably 0.1 to 1.0 percent by weight, more preferably 0.2 to 0.7 percent by weight, in each case based on the conditioning medium.

In accordance with the invention, it is important that the conditioning medium includes a higher-boiling solvent having a dipole character. The higher-boiling solvent having a dipole character is preferably an aprotic solvent which has an electric dipole moment. Such higher-boiling solvents preferably have a boiling point of more than 100 degrees Celsius at normal pressure, more preferably more than 110 degrees Celsius at normal pressure and even more preferably more than 120 degrees Celsius at normal pressure. Even though these are not properly capable of partially dissolving the high-temperature-resistant plastics, they do, however, unexpectedly have a positive effect when these plastics contain filler. Especially suitable higher-boiling solvents having a dipole character are, for example, phenol, diphenyl sulfone, cyclohexanone, acetylacetone and ethylene glycol, especially dimethyl sulfoxide. The amount of higher-boiling solvent having a dipole character is from 5 to 99.9% by weight, preferably from 10 to 98% by weight, more preferably from 20 to 95% by weight, in each case based on the conditioning medium.

Optionally, a low-boiling solvent can also be a constituent of the conditioning medium. Such low-boiling solvents preferably having a boiling point of up to 100 degrees Celsius at normal pressure. These solvents may be water, alcohols such as, for example, methanol, ethanol, propanol etc., ketones and/or diketones such as, for example, acetone, methyl ethyl ketone, butanedione etc. and/or mixtures thereof, for example in amounts of 0.1-90 percent by weight, preferably 0.5-50 percent by weight, more preferably 1-30 percent by weight, in each case based on the conditioning medium.

In addition to the components mentioned hereinbefore, other additives can also be useful. Accordingly, for example, when applying hardenable mixtures based on methacrylates to the shaped article of high-temperature-resistant plastic there may be added lesser amounts of hydroxy(meth)acrylates such as, for example, hydroxyethyl(meth)acrylate, hydroxypropyl(meth)acrylate etc., alkyl(meth)acrylates such as, for example, methyl(meth)acrylate, ethyl(meth)acrylate etc. and/or di- and/or poly-(meth)acrylates such as, for example, urethane di(meth)acrylates, bis-phenol A di(meth)acrylates, trimethylol propane di(meth)acrylate, triethylene glycol di(meth)acrylate.

Further constituents may also be stabilisers, inhibitors, antioxidants.

It is self-evident that the above statements relating to the individual components such as, for example, high-temperature-resistant plastic, fillers, adhesive agents, higher-boiling solvents etc. also apply to the embodiments that follow.

The present invention furthermore includes use of a conditioning medium comprising an adhesive agent and a higher-boiling solvent having a dipole character in mediating in the adhesion of a hardenable mixture to a shaped article comprising a high-temperature-resistant plastic and a filler.

The present invention relates also to conditioned shaped articles comprising a high-temperature-resistant plastic and a filler, the shaped article having been conditioned with a conditioning medium and the conditioning medium comprising an adhesive agent and a higher-boiling solvent having a dipole character. The conditioned shaped article according to the invention can additionally be provided with a hardenable mixture.

Furthermore, the present invention relates to a method of conditioning at least a part of the surface of a shaped article comprising a high-temperature-resistant plastic and a filler using a conditioning medium comprising an adhesive agent and a higher-boiling solvent having a dipole character, the method comprising the following steps:
application of the conditioning medium to at least a part of the surface of the shaped article,
allowing the conditioning medium to work in, and,
optionally, applying a hardenable mixture to that surface of the shaped article which has been conditioned with conditioning medium.

The expression “at least a part of the surface of the shaped article” means that at least 10% by area of the surface of the shaped article, preferably at least 50% by area, more preferably at least 80% by area, most preferably substantially all of the surface of the shaped article is treated with the conditioning medium.

The conditioning media according to the invention can be used at temperatures up to 200° C., preferably up to 150° C., more preferably up to 100° C., especially at room temperature. They are preferably applied in a thin layer of 0.01-0.2 mm and have a working-in time on the surface of the shaped article of 1-60 minutes, preferably 1-30 minutes, especially 1-15 minutes.

The present invention relates also to conditioned shaped articles obtainable by the above method.

The conditioned shaped articles according to the invention can be shaped dental articles, preferably dentures, parts of dentures, crowns, bridges, inlays, onlays etc.

The described conditioning media according to the invention are very well suited to creating a good connection of hardenable mixtures to high-temperature-resistant thermoplastics.

Applications in the dental sector may be, for example, veneers of pre-manufactured, for example injection-moulded or milled, semi-finished crowns or copings made of high-temperature-resistant thermoplastics, for example PEEK with light-polymerisable, aesthetic methacrylate composite masses as veneer.

The Examples that follow are intended to explain in greater detail the action of conditioning media according to the invention as bonding agents between light-hardenable methacrylate composite (NEPA®FIL, Merz Dental, Germany) and high-temperature-resistant, glass-fibre-filler-containing PEEK thermoplastic (Dentanium, Wegold, Germany).

For the adhesion values resulting from shear, test specimens made of Dentanium were blasted with corundum (50 μm), wetted with the various conditioning media according to Examples 1-6 and allowed to work in for 2 minutes. The conditioning medium was then blown using a clean air stream, and a cylinder having a diameter of about 3 mm of a light-hardenable dental plastic (NEPA®FIL, Merz Dental) was applied and hardened for 90 seconds in a Dentacolor® XS light-hardening apparatus (Heraeus Kulzer).

The method of measuring the shear was preferably carried out in accordance with Gabel R and Welker D, Quintessenz Zahntech (2001) 27:197-203, Gebel R and Welker D, Quintessenz Zahntech (2000) 26:733-743, Gabel R and Welker D, ZWR (2004) 113:306-313.

Using the embodiments according to the invention, especially the method according to the invention, the conditioned shaped article according to the invention and the conditioning medium according to the invention, it is possible to obtain, in accordance with the above measuring method, measurement values of at least 8 MPa, preferably at least 10 MPa, more preferably at least 12 MPa, and even more preferably at least 14 MPa.

For the adhesion test by shearing, the test specimens were stored for 1 hour in water at 60° C. and were then subjected to shearing. The adhesion results are summarised hereinbelow.

In Comparison Example 1 the composite was polymerised onto the Dentanium without further conditioning. (4.2 MPa).

In Comparison Example 2 the composite was polymerised onto the Dentanium using conditioning not in accordance with the invention with ethanol. (4.8 MPa).

In Comparison Example 3 the composite was polymerised onto the Dentanium using conditioning not in accordance with the invention with DMSO. (5.2 MPa).

In Comparison Example 4 the composite was polymerised onto the Dentanium using conditioning not in accordance with the invention with a methacryl silane in ethanol (Fantestic CerBond, R-Dental). (5.0 MPa).

In Example 5 according to the invention the composite was polymerised onto the Dentanium using a conditioning medium according to the invention consisting of 98 parts of DMSO and 2 parts of methacryl silane (Fantestic CerBond, R-Dental). (15.2 MPa).

In Example 6 according to the invention the composite was polymerised onto the Dentanium using a conditioning medium according to the invention consisting of 50 parts of DMSO, 48 parts of ethanol and 2 parts of methacryl silane (Fantestic CerBond, R-Dental). (14.4 MPa).

1-18. (canceled)

19. A method of conditioning the surface of a shaped article containing a high-temperature-resistant plastic and a filler comprising:
applying a conditioning medium comprising an adhesive agent and a higher-boiling solvent having a dipole character to at least a part of the surface of a shaped article containing a high-temperature-resistant plastic and a filler;
allowing the conditioning medium to work in; and
optionally, applying a hardenable mixture to that surface of the shaped article which has been conditioned with the conditioning medium.

20. The method of claim 19, wherein the conditioning medium is used at temperatures of up to 200° C., up to 100° C., or at room temperature.

21. The method of claim 19, wherein the working-in time of the conditioning medium on the surface of the shaped article is 1 to 60 minutes, 1 to 30 minutes, or 1 to 15 minutes.

22. A conditioned shaped article produced by the method of claim 19.

23. The conditioned shaped article of claim 22, characterized in that it is in the form of a shaped dental article.

24. The conditioned shaped article of claim 23, characterized in that it is in the form of dentures, parts of dentures, crowns, bridges, inlays, or onlays.

25. The conditioned shaped article of claim 22, wherein the high-temperature-resistant plastic is a polyarylate, polyarylene sulfide, polysulfone, liquid crystal polymer, polyimide, polyetherimide, polyamidimide, polyaryl ether ketone or a copolymerization product of at least two of the afore-mentioned polymers or a blend of at least two of the afore-mentioned polymers.

26. The conditioned shaped article of claim 22, wherein the filler present in the shaped article comprises glass fibres, glass spheres, glass flour, silicic acids, quartz flour, mica, corundum, kaolin, talc, inorganic pigments, apatites or mixtures thereof.

27. The conditioned shaped article of claim 22, wherein the filler is surface-treated with functional silanes, phosphoric acid esters, phosphonic acid esters, carboxylic acid esters or mixtures thereof.

28. The conditioned shaped article of claim 22, wherein the conditioning medium further comprises one or more of the following components:
one or more catalysts;
a low-boiling solvent; or
additives selected from the group of stabilizers, inhibitors, antioxidants or mono- and/or poly-functional (meth)acrylates.

29. The conditioned shaped article of claim 22, wherein the adhesive agent is
a functional silane selected from the group of a vinyl silane, (meth)acryl silane, epoxy silane, amino silane, hydroxy silane or a mixture thereof; or
a functional phosphoric acid ester, phosphonic acid ester or carboxylic acid ester or a mixture thereof.

30. The conditioned shaped article of claim 22, wherein the adhesive agent comprises components of the hardenable mixture based on monomers having (meth)acrylate, vinyl, epoxide, isocyanate or other groups.

31. The conditioned shaped article of claim 22, wherein the higher-boiling solvent having a dipole character is selected from the group of dimethyl sulfoxide, phenol, diphenyl sulfone, acetylacetone or ethylene glycol.

32. The conditioned shaped article of claim 22, wherein the hardenable mixture is formed on the basis of monomers having (meth)acrylate, vinyl, epoxide, isocyanate or other groups.

33. A kit comprising
(i) a shaped article comprising a high-temperature-resistant plastic and a filler,
(ii) a conditioning medium comprising an adhesive agent and a higher-boiling solvent having a dipole character; and
(iii) optionally, a hardenable mixture.

34. The kit of claim 33, wherein the high-temperature-resistant plastic is a polyarylate, polyarylene sulfide, polysulfone, liquid crystal polymer, polyimide, polyetherimide, polyamidimide, polyaryl ether ketone or a copolymerization product of at least two of the afore-mentioned polymers or a blend of at least two of the afore-mentioned polymers.

35. The kit of claim 33, wherein the filler present in the shaped article comprises glass fibres, glass spheres, glass flour, silicic acids, quartz flour, mica, corundum, kaolin, talc, inorganic pigments, apatites or mixtures thereof.

36. The kit of claim 33, wherein the filler is surface-treated with functional silanes, phosphoric acid esters, phosphonic acid esters, carboxylic acid esters or mixtures thereof.

37. The kit of claim 33, wherein the conditioning medium further comprises one or more of the following components:
one or more catalysts;
a low-boiling solvent; or
additives selected from the group of stabilizers, inhibitors, antioxidants or mono- and/or poly-functional (meth)acrylates.

38. The kit of claim 33, wherein the adhesive agent is
a functional silane selected from the group of a vinyl silane, (meth)acryl silane, epoxy silane, amino silane, hydroxy silane or a mixture thereof; or
a functional phosphoric acid ester, phosphonic acid ester or carboxylic acid ester or a mixture thereof.

39. The kit of claim 33, wherein the adhesive agent comprises components of the hardenable mixture based on monomers having (meth)acrylate, vinyl, epoxide, isocyanate or other groups.

40. The kit of claim 33, wherein the higher-boiling solvent having a dipole character is selected from the group of dimethyl sulfoxide, phenol, diphenyl sulfone, acetylacetone or ethylene glycol.

41. The kit of claim 33, wherein the hardenable mixture is formed on the basis of monomers having (meth)acrylate, vinyl, epoxide, isocyanate or other groups.

42. A conditioned shaped article comprising a high-temperature-resistant plastic and a filler, wherein the shaped article has been conditioned with a conditioning medium and the conditioning medium comprises an adhesive agent and a higher-boiling solvent having a dipole character.

43. The conditioned shaped article of claim 42, wherein the conditioned shaped article has additionally been provided with a hardenable mixture.
